(19) United States
(12) Patent Application Publication
(10) Pub. No.: US 2014/0173116 A1
(43) Pub. Date: Jun. 19, 2014

(54) APPARATUS AND METHOD FOR SHARING RESOURCE BETWEEN TERMINALS

(71) Applicant: Electronics and Telecommunications Research Institute, Daejeon (KR)

(72) Inventors: Hyun Joong KANG, Gyeongsangnam-do (KR); Jun Wook LEE, Chungcheongbuk-do (KR); Bong Wan KIM, Daejeon (KR); Sung Soo KANG, Daejeon (KR); Hyo Chan BANG, Daejeon (KR)

(73) Assignee: Electronics and Telecommunications Research Institute, Daejeon (KR)

(21) Appl. No.: 13/970,282

(22) Filed: Aug. 19, 2013

(30) Foreign Application Priority Data
Dec. 17, 2012 (KR) 10-2012-0147428

(51) Int. Cl. H04L 12/911

(52) U.S. Cl. CPC H04L 47/70
USPC 709/226

(57) ABSTRACT

A resource sharing apparatus which allows a first terminal and a second terminal to share a resource includes a virtual node generating unit which generates a virtual node corresponding to the second terminal in a storing space in the first terminal, and a sharing control unit which transmits sharing data to the second terminal through the virtual node, if information on at least one resource which is permitted to be shared with the second terminal, among the resources of the first terminal, is generated, deleted, or changed.

### CROSS-REFERENCE TO RELATED APPLICATIONS

This application claims priority to and the benefit of Korean Patent Application No. 10-2012-0147428 filed in the Korean Intellectual Property Office on Dec. 17, 2012, the entire contents of which are incorporated herein by reference.

### TECHNICAL FIELD

The present invention relates to an apparatus for sharing a resource which is capable of sharing at least a part of resources possessed by each apparatus between terminals which may interwork to each other through a network to allow the information to be interworked between the terminals in real time and a method thereof.

### BACKGROUND ART

In recent years, as performance of a processor and a memory and data communication technology are developed, numerous devices interwork with each other through a cable or wirelessly so as to access various information at anywhere at a ultrahigh speed. Further, a program or a service is developed so as to duplicate information contained in the terminal, share the information through cloud based systems which are connected by a network and a user may check the information at anywhere and duplicate and synchronize the information as much as a user wants. When a resource such as data and a disk are shared, the user may rapidly and conveniently collect, process, and share the information.

For example, if a user browses a web page from any one of plural terminals which are registered by a specific application, in the service, the web page is stored in a cloud based storage device. If the user drives the same application in another terminal, the application may allow the user to confirm the accessed web page through a list of terminals which browse the web page in recent time and the terminal. By doing this, the user may promptly share information, which has been shared by sending an e-mail or text message in the related art, without making any effort therefor. However, in the present time, only a uniquely designated item or function is shared in specific applications, but limited to operate only in the application and is not shared, modified, and corrected between the applications. Further, if the user wants to use data such as complex information or moving picture of other terminal, or an image captured by a camera, data which is created or captured by another terminal is transmitted and then the information may be used.

### SUMMARY OF THE INVENTION

The present invention has been made in an effort to provide an apparatus for sharing a resource which is capable of sharing at least a part of resources possessed by apparatus between terminals which may interwork to each other through a network to allow the information to be interworked between the terminals in real time and a method thereof.

An exemplary embodiment of the present invention provides a resource sharing apparatus which shares a resource between a first terminal and a second terminal, which may include a virtual node generating unit which generates a virtual node corresponding to the second terminal in a storing space in the first terminal, and a sharing control unit which transmits sharing data to the second terminal through the virtual node, if information on at least one resource which is permitted to be shared with the second terminal, among the resources of the first terminal, is generated, deleted, or changed.

The resource sharing apparatus may further include a resource management unit which provides information on a sharable resource among resources possessed in the first terminal to the second terminal in response to a resource sharing request of the second terminal.

When the second terminal transmits information on a desired sharing resource and information on a corresponding sharable resource of the second terminal to the first terminal in response to the providing of the information on the sharable resource, the virtual node generating unit may generate a virtual node which possesses the sharable resource of the second terminal.

When information on at least one resource is generated, deleted, or modified, the sharing control unit may transmits the information on the resource to the second terminal and may transmit sharing data to the first terminal through the virtual node in response to the resource sharing request of the second terminal.

The resource sharing apparatus may further include a sharing memory in which data is stored by the second terminal and a third terminal and which is shared by the second terminal and the third terminal as a resource which is permitted to be shared.

At least one resource which is permitted to be shared may include an external device which is connected to the first terminal through a cable or wirelessly.

An exemplary embodiment of the present invention provides a resource sharing method which shares a resource between a first terminal and a second terminal, which may include generating a virtual node corresponding to the second terminal in a storing space in the first terminal, and transmitting sharing data to the second terminal through the virtual node, if information on at least one resource which is permitted to be shared with the second terminal, among the resources of the first terminal, is generated, deleted, or changed.

The resource sharing method may further include transmitting information on a sharable resource among resources possessed in the first terminal to the second terminal in response to a resource sharing request of the second terminal.

The resource sharing method may further include allowing the second terminal to transmit information on a desired sharing resource and information on a corresponding sharable resource of the second terminal to the first terminal in response to the transmission of the information on the sharable resource and the generating of a virtual node may generate a virtual node which possesses the sharable resource of the second terminal.

The transmitting may include, when information on at least one resource is generated, deleted, or modified, delivering the information on the resource to the second terminal and transmitting sharing data to the first terminal through the virtual node in response to the resource sharing request of the second.

According to the present invention, at least a part of resources possessed by individual devices is shared between terminals which may interwork with each other through a network so as to interwork the information between the terminals in real time so that distributed resources may be efficiently used and the information may be efficiently duplicated and shared.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a block diagram illustrating a resource sharing system according to an exemplary embodiment of the present invention.

FIG. 2 is a flowchart illustrating a process of defining a resource which is permitted to be shared between terminals and generating a virtual node according to an exemplary embodiment of the present invention.

FIG. 3 is a flowchart illustrating a process where the resource is shared between terminals according to the exemplary embodiment of the present invention.

FIG. 4 is a block diagram illustrating a resource sharing system according to another exemplary embodiment of the present invention.

FIG. 5 is a block diagram illustrating a resource sharing system according to still another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing

### DETAILED DESCRIPTION

Hereinafter, exemplary embodiments of the present invention will be described in detail with reference to the drawings. Substantially same components in the following description and the accompanying drawings may be denoted by the same reference numerals and redundant description will be omitted. Further, in the description of the exemplary embodiment, if it is considered that specific description of related known configuration or function may cloud the gist of the present invention, the detailed description thereof will be omitted.

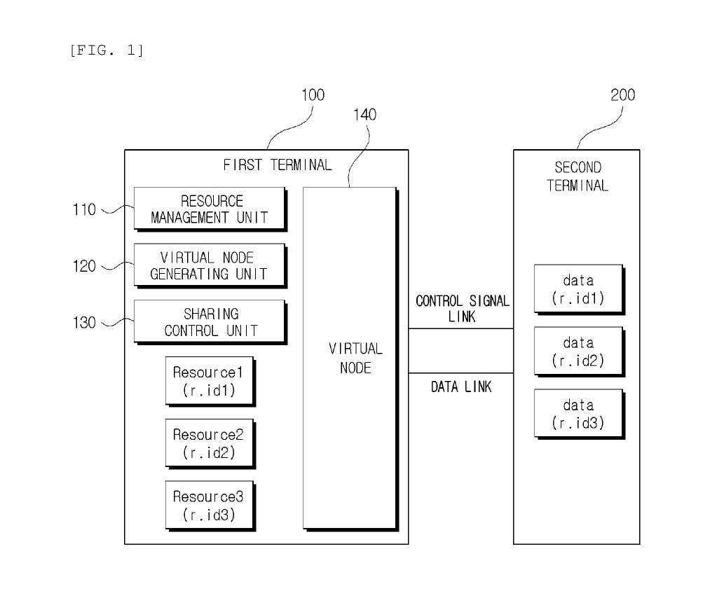

FIG. 1 is a block diagram illustrating a resource sharing system according to an exemplary embodiment of the present invention. A resource sharing system according to an exemplary embodiment includes a first terminal 100 and a second terminal 200 which may share the resource and the first terminal 100 includes a resource sharing device which allow the resource to be shared between the first terminal 100 and the second terminal 200. According to the exemplary embodiment, it is described that the resource sharing device is provided in the first terminal 100, but the resource sharing device may be provided in both the first terminal 100 and the second terminal 200.

In this exemplary embodiment, the first terminal 100 and the second terminal 200 possess various resources. The first terminal 100 and the second terminal may be fixed terminals (for example, PC or IPTV) or mobile terminals (smart phone or tablet PC). Desirably, at least one of the first terminal 100 and the second terminal may be a mobile terminal. For example, both the first terminal 100 and the second terminal 200 may be mobile terminals or the first terminal 100 may be a fixed terminal and the second terminal 200 may be a mobile terminal.

A resource includes various types of hardware, software, and data which are provided in the terminal and (hardware type or software type or both types of) a specific function module (for example, a camera, a sound, a mouse, a keyboard, or a display), a specific application, a specific type of data (for example, email data, authentication data, or specific file format of data), a specific type of content (for example, moving picture, music, or e-book), a specific storing space (for example, a specific folder) may be the resource. Further, the resource may be an external device which is connected to the terminal through a cable or wirelessly so as to allow the terminal to directly use a function of the external device.

The second terminal 200 is a terminal which wants to share the resource possessed by the first terminal 100 and the first terminal 100 is a terminal which permits the second terminal 200 to share the resource of the first terminal. Simultaneously, the first terminal 100 may be a terminal which wants to share the resource possessed by the second terminal 200 and the second terminal 200 is a terminal which permits the first terminal 100 to share the resource of the second terminal. In this case, as described above, the resource sharing device may be provided in both the first terminal 100 and the second terminal 200.

Referring to FIG. 1, the resource sharing device provided in the first terminal 100 includes a resource management unit 110, a virtual node generating unit 120, and a sharing control unit 130.

The resource management unit 110 generates specification information on each of resources which may be shared with other terminal, among resources possessed by the first terminal 100, and assigns an identifier (hereinafter, referred to as a resource ID) to each resource. The resource management unit 110 provides the resource specification information and the resource ID to the second terminal 200. Referring to FIG. 1, resource IDs r.id1, r.id2, and r.id3 are assigned to resources Resource1, Resource2, and Resource3, respectively.

The second terminal 200 may determine whether to be capable of sharing the resource of the first terminal 100 based on the resource specification information provided from the first terminal 100 and a function and a resource possessed by itself. In accordance with the determination result, the second terminal 200 transmits a resource ID of a desired sharing resource and information on a sharable resource of the second terminal 200 corresponding to or related with the desired sharing resource to the first terminal 100.

The virtual node generating unit 120 generates a virtual node 140 which corresponds to the second terminal 200 which is permitted to share the resource, in a storing space in the first terminal 100. The virtual node 140 is a logical object which virtualizes or abstracts the physical second terminal 200. That is, the virtual node 140 is a logical object which maps and abstracts a resource of a part of module or service of the second terminal 200 in order to allow the second terminal 200 to share the resource of the first terminal 100. Therefore, the virtual node generating unit 120 may generate virtual node 140 so as to possess a sharable resource of the second terminal 200 provided from the second terminal 200.

When information on resources which are permitted to be shared with the second terminal 200 among the resources of the first terminal 100 is generated, deleted, or modified, the sharing control unit 130 transmits corresponding sharing data to the second terminal 200 through the virtual node 140. That is, if the virtual node 140 receives the sharing data from the sharing control unit 130, the virtual node 140 generates, deletes, or modifies information on the resource and transmits the sharing data to the second terminal 200 in real time. For example, referring to FIG. 1, the sharing data corresponding to each of the resource IDs r.id1, r.id2, and r.id3 may be transmitted to the second terminal 200.

Referring to FIG. 1, a control signal link which is an asynchronous signal link and a data link which is a real-time signal link are formed between the first terminal 100 and the second terminal 200. When the resource specification information is provided, the information on the sharable resource is transmitted, and information on the resource which is permitted by the first terminal 100 to be shared is generated, deleted, or modified as described above, a preparing process of sharing the resource with the second terminal 200 may be performed through the control signal link. The resource may be shared in real time, that is, the sharing data is transmitted through the data link.

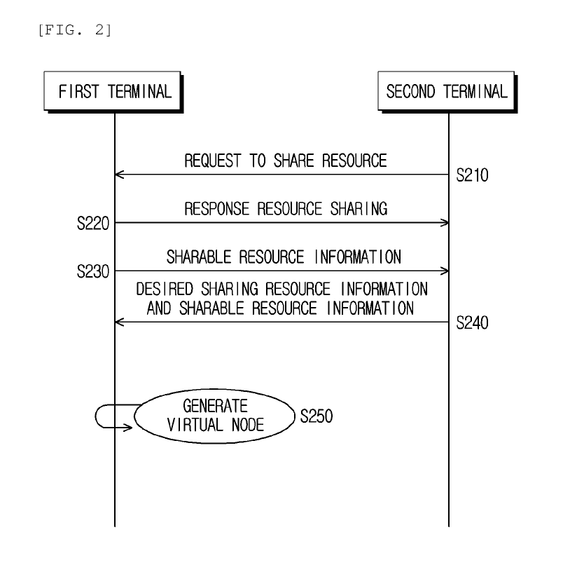

FIG. 2 is a flowchart illustrating a process of defining a resource which is permitted to be shared between the first terminal 100 and the second terminal 200 and generating a virtual node according to an exemplary embodiment of the present invention.

In step S210, the second terminal 200 which wants to share the resource possessed by the first terminal 100 transmits a resource sharing request message which requests to permit to share the resource to the first terminal 100.

In step S220, the first terminal 100 confirms whether the second terminal 200 has an authority to share the resource and transmits a resource sharing response message which permits to share at least a part of resources possessed by the first terminal 100 with the second terminal 200 in response to the resource sharing request message. In this case, the first terminal 100 generates a virtual node ID corresponding to a virtual node which will be generated thereafter and transmits the virtual node ID so as to be included in the resource sharing response message. The second terminal 200 which receives the resource sharing response message confirms that the second terminal 200 may share the resource of the first terminal 100 and maps the virtual node ID received from the first terminal 100 to the second terminal.

In step S230, the first terminal may transmit information on a resource which may be shared with the second terminal 200 among the resources possessed by itself. In this case, information to be transmitted may be specification information of the resource for a sharable resource or a resource ID of the resource.

The second terminal 200 may determine whether to be capable of sharing the resource of the first terminal 100 based on the resource specification information received from the first terminal 100 and a function and a resource possessed by itself and determine whether to share the resource. The determination whether to share the resource may be performed by selection of the user.

In step S240, the second terminal 200 which selects a resource to be shared transmits information on a resource which is desired to be shared to the first terminal 100. In this case, the second terminal 200 may transmit a resource ID of the resource which is desired to be shared. The second terminal 200 may transmit information on a sharable resource of the second terminal 200 which corresponds to the resource which is desired to be shared or is related with the resource which is desired to be shared to the first terminal 100. The information on the sharable resource of the second terminal 200 may include specification information of the resource and a resource ID which is assigned to the resource by the second terminal 200.

The first terminal 100 which receives the information on the resource which is desired to be shared and the information on the sharable resource from the second terminal 200 generates the virtual node 140 corresponding to the second terminal 200 in the storing space of the first terminal 100. The virtual node 140 to be generated may be generated so as to possess a sharable resource of the second terminal 200 confirmed from the second terminal 200.

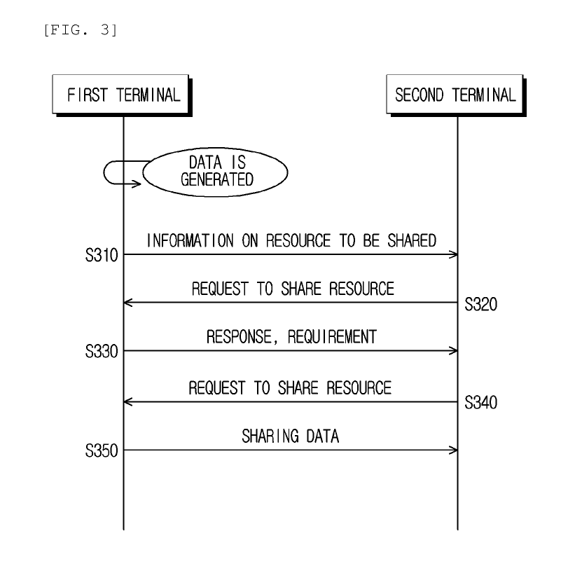

FIG. 3 is a flowchart illustrating a process of sharing a resource between the first terminal 100 and the second terminal 200 according to an exemplary embodiment of the present invention.

In step S310, if data indicating that information on a resource which is permitted to be shared with the second terminal is generated, deleted, or modified is generated in the first terminal 100, the first terminal 100 delivers the information on the resource to the second terminal. Transmitted information may be specification information of the resource and a resource ID. Here, as the specification information of the resource, only information on a type of the resource may be transmitted. In the exemplary embodiment, if the second terminal 200 already has the specification information of the resource, only the ID of the resource is transmitted.

The second terminal 200 which confirms the ID of the resource determines to share the resource. The resource may be determined not to be shared in accordance with the setting or the selection of the user. In this case, the second terminal 200 does not perform any more action or transmit a message indicating that the second terminal 200 does not share the resource to the first terminal 100. In step S310, a plurality of resource IDs may be transmitted. In this case, the second terminal 200 may select a part of resources to be shared. If the resource is determined to be shared, in step S320, the second terminal 200 transmits a resource sharing request message which requests to share the resource. Here, the resource sharing request message may include the resource ID of the resource which is desired to be shared.

In step S330, the first terminal 100 transmits a sharing permission message which permits to share the resource in response to the resource sharing request message. The resource sharing request message may include requirements to use the resource. In some cases, only when the terminal satisfies a specific requirement (for example, necessity for specific hardware or software or specifications of a device), the resource may be used.

In step S340, the second terminal 200 confirms whether to satisfy the requirements included in the resource sharing request message. If the requirements are satisfied, in step S340, the second terminal 200 transmits the resource sharing request message which requests to share the resource to the first terminal 100. The resource sharing request message may include a resource ID of the resource which is desired to be shared in accordance with the requirements. If the second terminal 200 does not satisfy the requirement, the second terminal 200 does not perform any more action or transmits a message indicating that the second terminal 200 does not share the resource to the first terminal 100.

In step S450, the first terminal 100 which receives the resource sharing request message transmits sharing data indicating that the information generated for the resource is generated, deleted, or changed to the second terminal 200 through the virtual node 140.

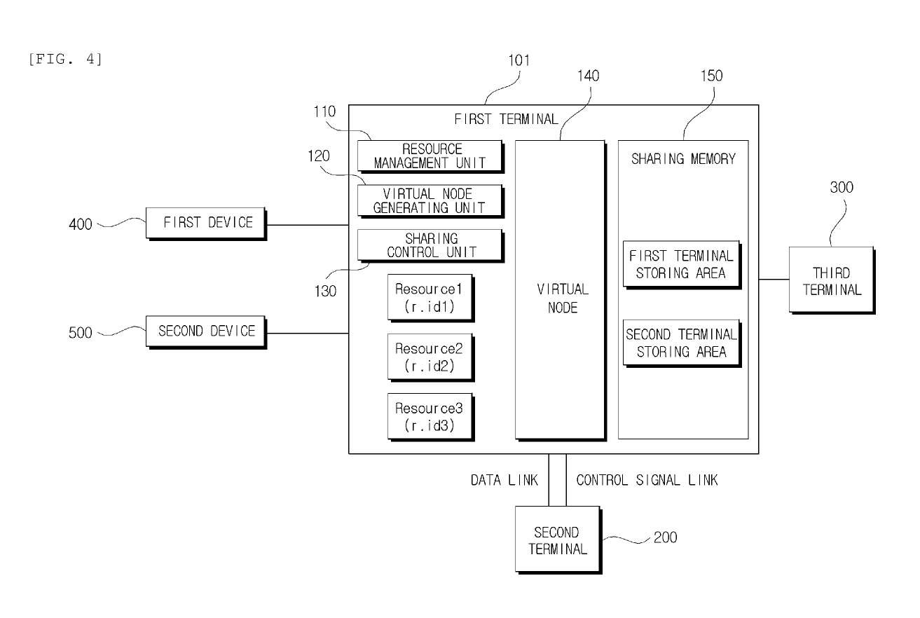

FIG. 4 is a block diagram illustrating a resource sharing system according to another exemplary embodiment of the present invention. The resource sharing system according to the exemplary embodiment includes a first terminal 101, a second terminal 200, and a third terminal 300. Further, a first device 400 or a second device 500 is connected to the first terminal as an external resource through a cable or wirelessly. A resource sharing device which is provided in the first terminal 101 may further include a sharing memory 150.

The sharing memory 150 is a storing space which is shared by the second terminal 200 and the third terminal 300 to store data therein. The sharing memory 150 provides a storing space for the second terminal 200 and a storing space for the third terminal 300. If such a sharing memory 150 is set as a sharable resource, the second terminal 200 and the third terminal 300 may exchange information through the sharing memory 150 in the first terminal 101. The information which is exchanged through the sharing memory 150 may be status information of terminals and surrounding environment information. If the second terminal 200 and the third terminal 300 are present in physically separated spaces, the second terminal 200 and the third terminal 300 may hold the same status information and the surrounding environment through the exchange of the information even when the second terminal 200 and the third terminal 300 have separate spaces. For example, if the first terminal 101 and the third terminal 300 are positioned at home and the second terminal 200 is moving outside the home, the second terminal 200 may share the same status and neighboring environment as the third terminal 300 at home.

Further, if a first device 400 (or a second device 500) which is an external resource is set as a sharable resource, the second terminal 200 may remotely confirm the information and the status of the first terminal 400. Further, the second terminal 200 controls the first device 400 remotely through the first terminal 101 and as a result, the data is periodically received. Accordingly, the second terminal 200 may remotely utilize the external resource which is connected to the first terminal 100 as if the resource is possessed by itself. If the second terminal 200 possesses a resource corresponding to the external resource, information on the external resource may be reflected to the resource which is possessed by itself.

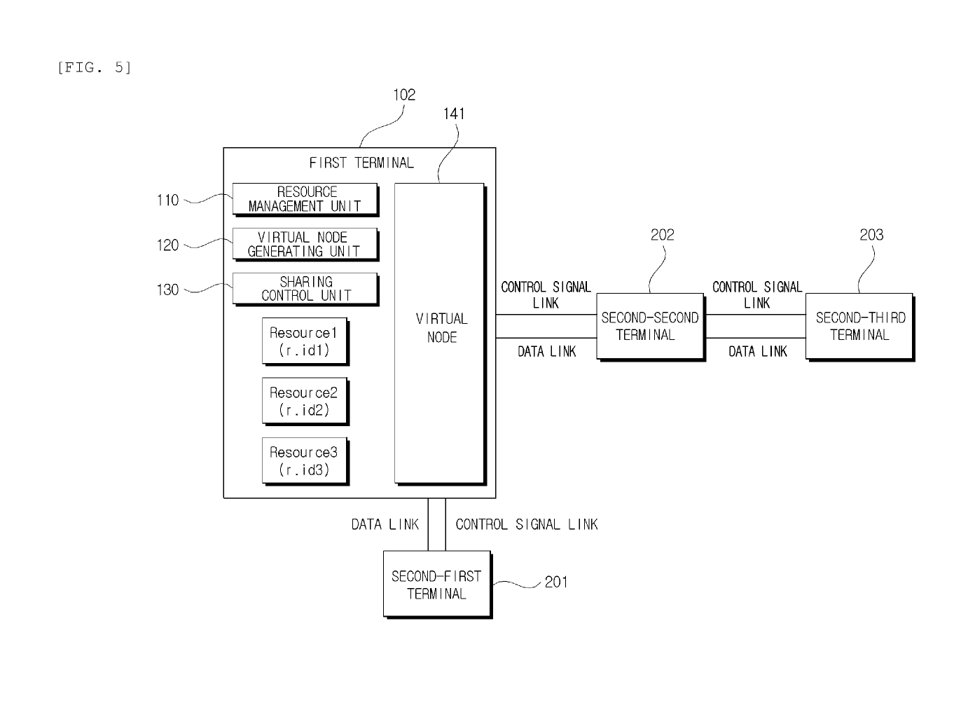

FIG. 5 is a block diagram illustrating a resource sharing system according to still another exemplary embodiment of the present invention and a plurality of terminals which want to share the resource possessed by the first terminal 102 are provided.

In the exemplary embodiment described with reference to FIG. 1, the virtual node 140 corresponds to one second terminal 200. In the meantime, in this exemplary embodiment, the virtual node 141 corresponds to a plurality of terminals, for example, a second-first terminal 201, a second-second terminal 202, and a second-third terminal 203.

Information on a resource which is permitted to be shared with the second-first, second, and third terminals 201, 202, and 203 is generated, deleted, or modified, the first terminal 201 performs a preparing process of sharing the resource with the second-first, second, and third terminals 201, 202, and 203 and transmit the sharing data of the resource to the second-first, second, and third terminals 201, 202, and 203 through the control signal link.

In some cases, some of terminals which are permitted to share the resource of the first terminal 102 may not directly receive a control signal and sharing data from the first terminal 102. In this case, a control signal link and a data link are formed between sharable terminals to deliver a control signal and sharing data to a terminal which cannot receive the control signal and the sharing data from the terminal which may receive the control signal and the sharing data. For example, referring to FIG. 5, the second-second terminal 202 which forms the control signal link and the data link together with the first terminal 102 may form a control signal link and data link together with the second-third terminal 203 which cannot form a linkage with the first terminal 102. The second-second terminal 202 transmits the control signal and sharing data from the first terminal 102 to the second-third terminal 203 through the control link and the data link formed between the second-second terminal 202 and the second-third terminal 203.

The above-described exemplary embodiments of the present invention may be created by a computer executable program and implemented in a general use digital computer which operates the program using a computer readable medium. The computer readable recording medium includes a magnetic storage medium (for example, a ROM, a floppy disk, and hard disk), a storing medium such as an optical reading medium (for example, CD-ROM, a DVD).

For now, the present invention has been described with reference to the exemplary embodiments. It is understood to those skilled in the art that the present invention may be implemented as a modified form without departing from an essential characteristic of the present invention. Therefore, the disclosed exemplary embodiment may be considered as illustrative view point but as an explanatory aspect. The scope of the present invention may be interpreted by the appended claims and the technical spirit in the equivalent range is intended to be embraced by the invention.

What is claimed is:

1. A resource sharing apparatus which allows a first terminal and a second terminal to share a resource, the apparatus comprising:
a virtual node generating unit which generates a virtual node corresponding to the second terminal in a storing space in the first terminal, and
a sharing control unit which transmits sharing data to the second terminal through the virtual node, if information on at least one resource which is desired to be shared with the second terminal, among the resources of the first terminal, is generated, deleted, or changed.

2. The apparatus of claim 1, further comprising:
a resource management unit which provides information on a sharable resource among resources possessed in the first terminal to the second terminal in response to a resource sharing request of the second terminal.

3. The apparatus of claim 2, wherein when the second terminal transmits information on a desired sharing resource and information on a corresponding sharable resource of the second terminal to the first terminal in response to the providing of the information on the sharable resource, the virtual node generating unit generates a virtual node which possesses the sharable resource of the second terminal.

4. The apparatus of claim 1, wherein when information on at least one resource is generated, deleted, or modified, the sharing control unit transmits the information on the resource to the second terminal and transmits sharing data to the first terminal through the virtual node in response to the resource sharing request of the second.

5. The apparatus of claim 1, further comprising:
a sharing memory in which data is stored by the second terminal and a third terminal and which is shared by the second terminal and the third terminal as a resource which is permitted to be shared.

6. The apparatus of claim 1, wherein at least one resource which is permitted to be shared includes an external device which is connected to the first terminal through a cable or wirelessly.

7. A resource sharing method which allows a first terminal and a second terminal to share a resource, the method comprising:
generating a virtual node corresponding to the second terminal in a storing space in the first terminal, and
transmitting sharing data to the second terminal through the virtual node, if information on at least one resource which is permitted to be shared with the second terminal, among the resources of the first terminal, is generated, deleted, or changed.

8. The method of claim 7, further comprising:
transmitting information on a sharable resource among resources possessed in the first terminal to the second terminal in response to a resource sharing request of the second terminal.

9. The method of claim 8, further comprising:
allowing the second terminal to transmit information on a desired sharing resource and information on a corresponding sharable resource of the second terminal to the first terminal in response to the transmission of the information on the sharable resource,
wherein the generating of a virtual node generates a virtual node which possesses the sharable resource of the second terminal.

10. The method of claim 7, wherein the transmitting includes:
when information on at least one resource is generated, deleted, or modified, transmitting the information on the resource to the second terminal; and
transmitting sharing data to the first terminal through the virtual node in response to the resource sharing request of the second.
